(19) United States
(12) Patent Application Publication
(10) Pub. No.: US 2024/0127977 A1
(43) Pub. Date: Apr. 18, 2024

(54) APPARATUS FOR ELIMINATING RESIDUAL HEAT OF NUCLEAR REACTOR FOR VEHICLE MOUNTING

(71) Applicant: Korea Atomic Energy Research Institute, Daejeon (KR)

(72) Inventors: Kyung Jun KANG, Daejeon (KR); Sang Ji KIM, Daejeon (KR)

(73) Assignee: Korea Atomic Energy Research Institute, Daejeon (KR)

(21) Appl. No.: 18/323,548

(22) Filed: May 25, 2023

(30) Foreign Application Priority Data
Oct. 13, 2022 (KR) 10-2022-0131635
Feb. 20, 2023 (KR) 10-2023-0022063
Mar. 30, 2023 (KR) 10-2023-0041711

(51) Int. Cl. G21D 1/02; G21C 13/02

(52) U.S. Cl. CPC G21D 1/02; G21C 13/02

(57) ABSTRACT

An apparatus for eliminating residual heat of a nuclear reactor for vehicle mounting include: a reactor vessel in which molten salt flows; and a reactor cooler for cooling the reactor vessel. The reactor cooler includes: a first cooling unit including a heat medium that exchanges heat with the reactor vessel, and one or more heat dissipation pipes providing passages through which water coolant flows; and a second cooling unit configured to receive the water coolant discharged from the first cooling unit and cool the water coolant through an external fluid. The second cooling unit is configured such that the cooled water coolant flows into the first cooling unit in a normal position and in an abnormal position inclined to be perpendicular to the normal position.

### TECHNICAL FIELD

The present disclosure relates to an apparatus for eliminating residual heat of a nuclear reactor for vehicle mounting.

### BACKGROUND

A molten salt reactor is a fourth-generation nuclear reactor, which is a type of reactor in which nuclear fuel is melted in molten fluoride or chloride, obtained by melting salt at high temperatures and used as fuel and coolant instead of conventional solid nuclear fuel. In the event of an accident in a reactor, the temperature of the molten salt discharged from the reactor into a discharge tank is as high as 550 degrees, and the molten salt introduced into the discharge tank continuously releases residual heat into a containment building. This residual heat increases the temperature inside the containment building, thereby increasing the pressure in the containment building. In addition, since nuclear fuel is contained in the molten salt that may leak out of a reactor vessel due to damage to the reactor or the like, fission products generated from the molten salt may be harmful and dangerous to the human body.

Attempts have been made to install a molten salt reactor in a transportation means, such as a vehicle or a ship, in order to reduce the risk of damage caused by molten salt that may leak to the outside in the event of such a nuclear reactor accident. However, there is a problem in that the nuclear reactor cannot be normally operated in the event of an accident such as overturning of a vehicle or a transportation means although the nuclear reactor can be normally operated when the transportation means such as a vehicle or a ship is normally operated.

Accordingly, there is a need for an apparatus capable of operating a nuclear reactor normally even in the event of an accident such as overturning of a vehicle or the like.

### SUMMARY

Embodiments of the present disclosure have been devised in view of the above background, and an object of the present disclosure is to provide an apparatus for eliminating residual heat of a nuclear reactor for vehicle mounting, which can remove residual heat of a reactor vessel even when a vehicle is in the abnormal position such as overturning as well as in a normal position in which the vehicle is normally operated.

In accordance with an aspect of the present disclosure, there is provided an apparatus for eliminating residual heat of a nuclear reactor for vehicle mounting, the apparatus including: a reactor vessel in which molten salt flows; and a reactor cooler for cooling the reactor vessel, wherein the reactor cooler includes: a first cooling unit including a heat medium that exchanges heat with the reactor vessel, and one or more heat dissipation pipes providing passages through which water coolant flows; and a second cooling unit configured to receive the water coolant discharged from the first cooling unit and cool the water coolant through an external fluid, and wherein the second cooling unit is configured such that the cooled water coolant flows into the first cooling unit in a normal position and in an abnormal position inclined to be perpendicular to the normal position.

According to one embodiment of the present disclosure, the apparatus is installed in a transportation means such as a vehicle and can remove residual heat of molten salt flowing in a reactor vessel. In addition, residual heat of the reactor vessel can be removed by the first cooling unit and the second cooling unit of the reactor cooler even when the vehicle is in the abnormal position such as overturning as well as in a normal position in which the vehicle is normally operated.

### BRIEF DESCRIPTION OF THE DRAWINGS

FIG. 1 is a perspective view of a reactor residual heat removal apparatus according to an embodiment of the present disclosure, viewed from one side.

FIG. 2 is a perspective view of the reactor residual heat removal apparatus according to the embodiment of the present disclosure, viewed from the other side.

FIG. 3 is a perspective view of the reactor residual heat removal apparatus according to the embodiment of the present disclosure.

FIG. 4 is a view showing a state in which a reactor vessel has been separated from the reactor residual heat removal apparatus according to the embodiment of the present disclosure.

FIG. 5 is a view showing a first cooling unit and a second cooling unit of the reactor residual heat removal apparatus according to the embodiment of the present disclosure.

FIG. 6 is a view showing a jacket tank of the first cooling unit and the second cooling unit of the reactor residual heat removal apparatus according to the embodiment of the present disclosure.

FIG. 7 is a view showing a state in which a fluid tank opening and closing unit of the reactor residual heat removal apparatus according to the embodiment of the present disclosure is closed.

FIG. 8 is a view showing a state in which the fluid tank opening and closing unit of the reactor residual heat removal apparatus according to the embodiment of the present disclosure is opened.

FIG. 9 is a front view of a reactor cooler of the reactor residual heat removal apparatus according to the embodiment of the present disclosure when it is in a normal position.

FIG. 10 is a front view of the reactor cooler of the reactor residual heat removal apparatus according to the embodiment of the present disclosure when it is in a first abnormal position.

FIG. 11 is a front view of the reactor cooler of the reactor residual heat removal apparatus according to the embodiment of the present disclosure when it is in a second abnormal position.

FIG. 12 is a front view of the reactor cooler of the reactor residual heat removal apparatus according to the embodiment of the present disclosure when it is in a third abnormal position.

### DETAILED DESCRIPTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, ‘supported’ by, ‘transferred’ to, or ‘contacted’ with another element, it should be understood that the element may be directly connected to, supported by, transferred to, or contacted with another element, but that other elements may exist in the middle.

The terms used in the present disclosure are only used for describing specific embodiments, and are not intended to limit the present disclosure. Singular expressions include plural expressions unless the context clearly indicates otherwise.

Further, in the present disclosure, it is to be noted that expressions, such as the upper side, the lower side, and the side surface, are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

Hereinafter, a specific configuration of a reactor residual heat removal apparatus 1 for mounting on a vehicle according to an embodiment of the present disclosure will be described with reference to the drawings.

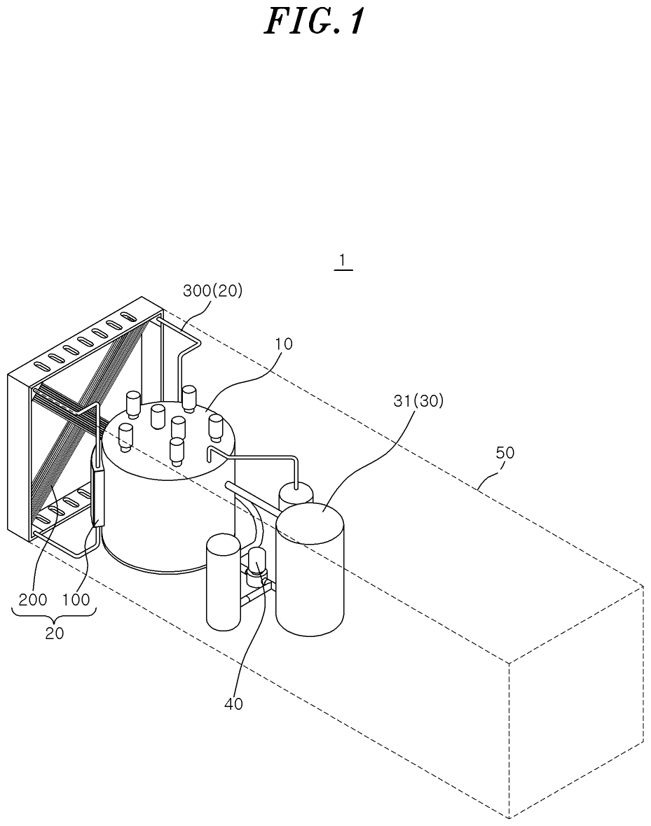

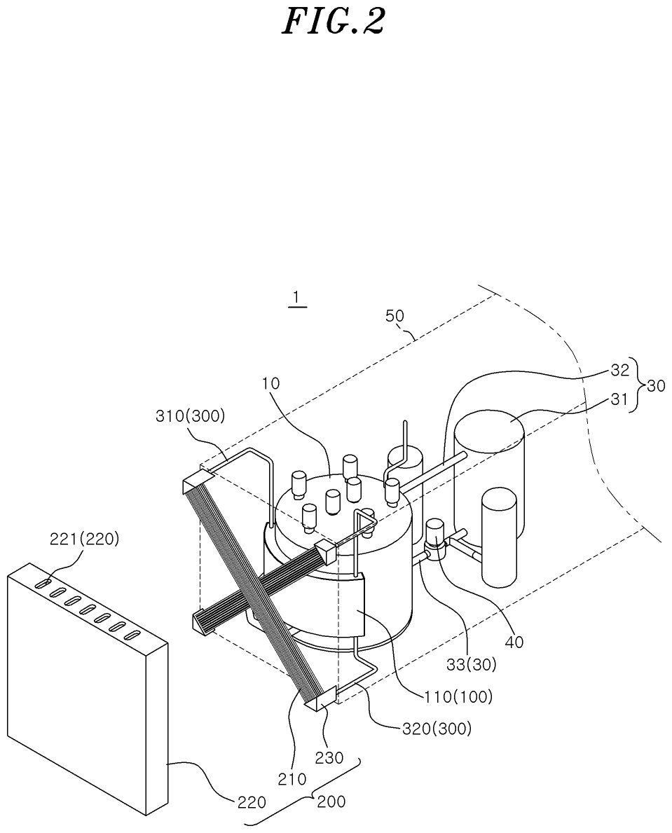

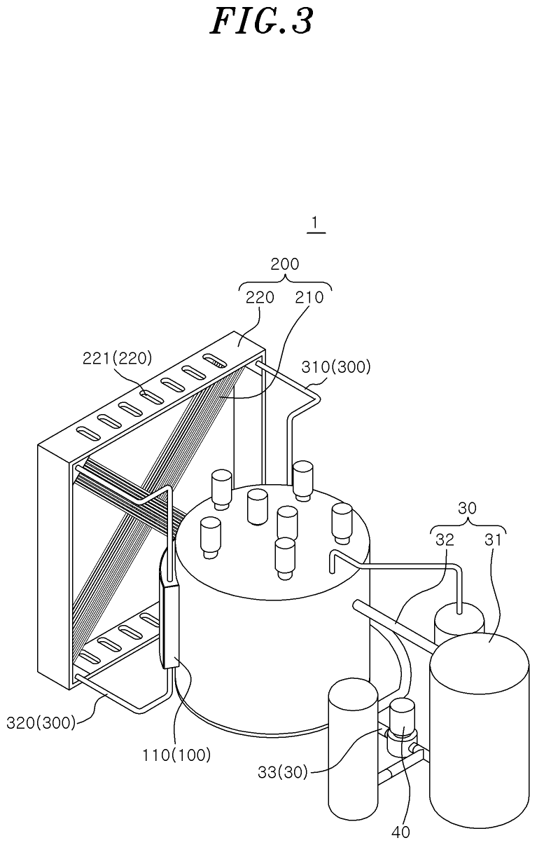

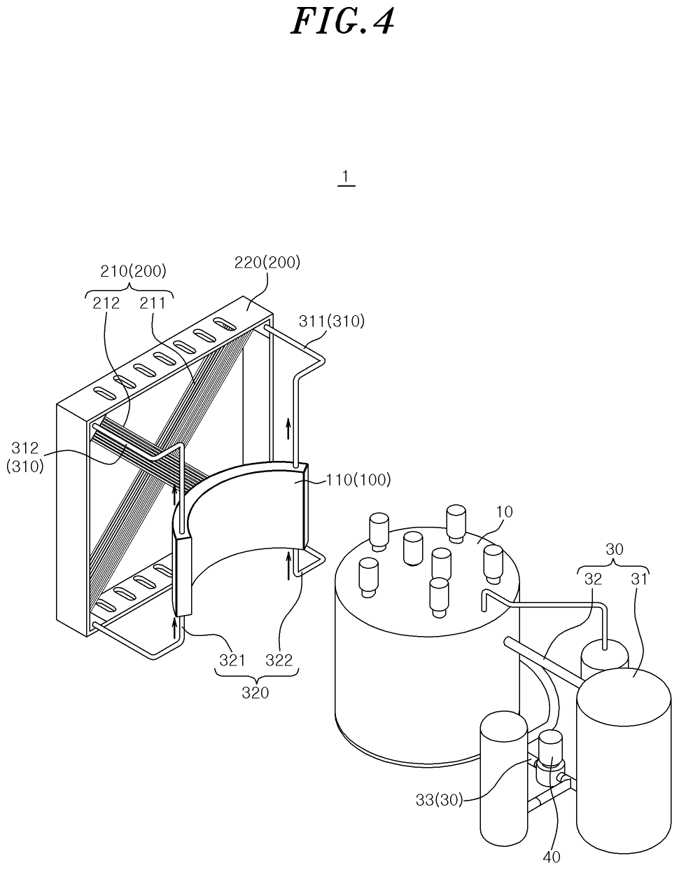

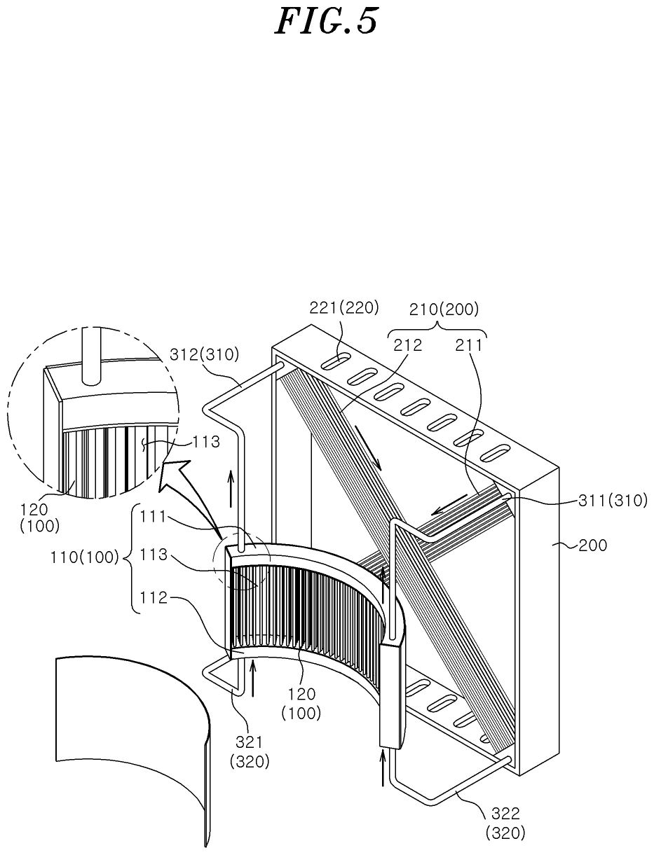

Referring to FIGS. 1 to 6, in the present embodiment, the reactor residual heat removal apparatus 1 for mounting on a vehicle (hereinafter, referred to as a reactor residual heat removal apparatus 1) is installed in a transportation means V such as a vehicle and can remove residual heat of the molten salt flowing in a reactor vessel 10. In the present specification, molten salt (not shown) may be fuel or coolant for a nuclear reactor in which nuclear fuel is melted in molten fluoride or sodium chloride in which sodium is dissolved at a high temperature. In addition, in the present specification, a nuclear reactor may be a molten salt reactor (MSR) using molten salt. The reactor residual heat removal apparatus 1 may include a reactor vessel 10, a reactor cooler 20, a molten salt cooler 30, a circulation pump 40, and a containment case 50. The reactor residual heat removal apparatus 1 may have a substantially rectangular parallelepiped shape.

Molten salt may flow in the reactor vessel 10. The molten salt in the reactor vessel 10 has a relatively high temperature and can be cooled by the reactor cooler 20 and the molten salt cooler 30. A reactor core provided with a fertile material in which a nuclear reaction occurs may be disposed inside the reactor vessel 10.

The reactor cooler 20 may cool the reactor vessel 10. The reactor cooler 20 may include a first cooling unit 100, a second cooling unit 200, and a flow line 300.

The first cooling unit 100 may accommodate a heat medium (for example, sodium) and water coolant W flows in the first cooling unit 100. Heat may be exchanged between the molten salt and a heat medium in the reactor vessel 10 so that the reactor vessel 10 cools.

The first cooling unit 100 may be configured such that the water coolant W in the first cooling unit 100 is heated by exchanging heat with the reactor vessel 10 and flows upward to be spaced apart from the ground when the reactor cooler 20 is in a normal position or the abnormal position. Here, the ground may be perpendicular to the direction of gravity or inclined at a predetermined angle with respect to the direction of gravity. In addition, the first cooling unit 100 may be formed such that evaporated gaseous water coolant W is discharged at the upper side relatively spaced from the ground and condensed liquid water coolant W is introduced at the lower side relatively adjacent to the ground when the reactor cooler 20 is in the normal position or the abnormal position. Meanwhile, the normal position is a state in which the nuclear reaction of the nuclear reactor can be controlled by control of a controller and may mean a state in which the reactor vessel 10, the reactor cooler 20, and the molten salt cooler 30 are disposed in a straight position with respect to the ground in a state in which the reactor residual heat removal apparatus 1 is installed in a transportation means V such as a vehicle. Further, the abnormal position may be a position inclined to be orthogonal to the normal position. The abnormal position is a state in which the nuclear reaction of the nuclear reactor cannot be controlled by control of the controller and may mean a state in which the reactor vessel 10, the reactor cooler 20, and the molten salt cooler 30 are not disposed in a straight position and are inclined with respect to the ground in the event of an accident such as overturning of a vehicle V in which the reactor residual heat removal apparatus 1 is installed. The first cooling unit 100 may include a jacket tank 110, a heat dissipation pipe 120, and a heat medium.

The jacket tank 110 may be filled with a heat medium and may communicate with a plurality of heat dissipation pipes 120. The jacket tank 110 may come into contact with the reactor vessel 10, and heat from the reactor vessel 10 may be transferred to the jacket tank 110. The jacket tank 110 may include a first manifold part 111, a second manifold part 112, and a flow part 113.

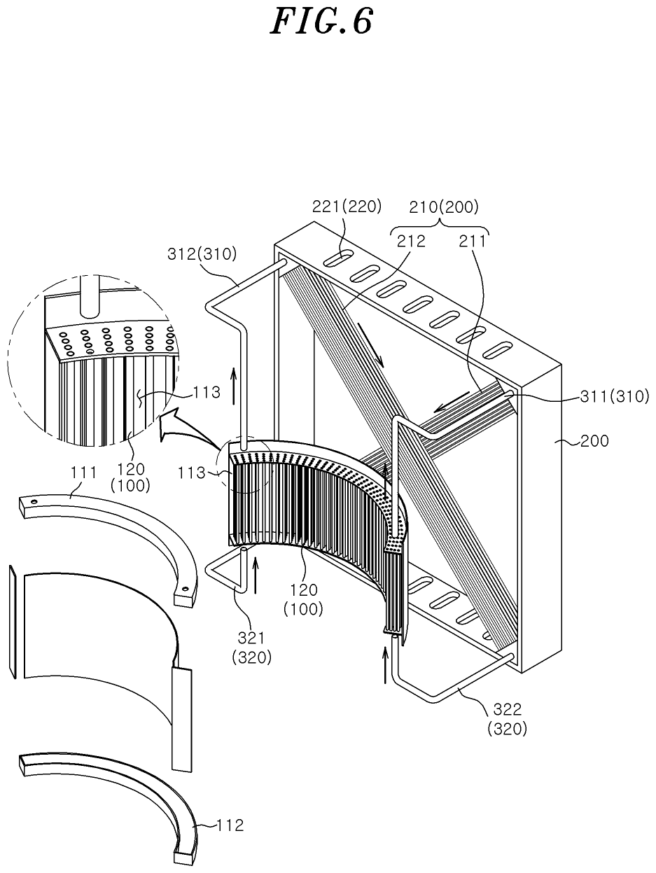

The first manifold part 111 may be connected to one side (upper end in FIG. 6) of the plurality of heat dissipation pipes 120 to communicate with the plurality of heat dissipation pipes 120. For example, a space in which gaseous water coolant W discharged from one side of the heat dissipation pipes 120 flows may be provided in the first manifold part 111. A flow passage 310 of the flow line 300 which will be described later may be connected to the first manifold part 111 to communicate therewith. The first manifold part 111 may be disposed above the jacket tank 110 in the normal position.

The second manifold part 112 may be connected to the other side (lower end in FIG. 6) of the plurality of heat dissipation pipes 120 to communicate with the plurality of heat dissipation pipes 120. A flow channel 320 of the flow line 300 which will be described below may be connected to the second manifold part 112 to communicate therewith. For example, a space in which liquid water coolant W introduced through the flow channel 320 flows may be provided in the second manifold part 112. The second manifold part 112 may be disposed under the jacket tank 110 in the normal position.

A heat medium (sodium) may be accommodated in the flow part 113. In addition, a plurality of heat dissipation pipes 120 may be disposed in the flow part 113 to be surrounded by the heat medium. In other words, the plurality of heat dissipation pipes 120 may be disposed in the flow part 113, and the heat medium such as sodium may be accommodated outside the plurality of heat dissipation pipes 120 and inside the flow part 113.

The heat dissipation pipe 120 may provide a passage through which the water coolant W flows. The water coolant W in the heat dissipation pipe 120 may exchange heat with the reactor vessel 10 in which molten salt flows. A plurality of heat dissipation pipes 120 may be provided and may be arranged to extend in an up and down direction within the flow part 113 in the normal position. The first manifold part 111 may be connected to one side (upper side in FIG. 6) of the plurality of heat dissipation pipes 120 to communicate therewith. In addition, the second manifold part 112 may be connected to the other side (lower side in FIG. 6) of the plurality of heat dissipation pipes 120 to communicate therewith.

The water coolant W in the heat dissipation pipes 120 can be heated by exchanging heat with the reactor vessel 10 in the normal position or the abnormal position so that the water coolant W flows upward to be spaced apart from the ground. In other words, the gaseous water coolant W evaporated through heat exchange with the reactor vessel 10 can flow upward from the ground within the heat dissipation pipes 120.

In addition, the water coolant W in the heat dissipation pipes 120 may flow at the lower inside thereof when the heat dissipation pipes 120 is in the normal position or the abnormal position. For example, the liquid water coolant W flowing into the second manifold part 112 through the flow channel 320 can flow into the other side (lower side in FIG. 6) of the heat dissipation pipes 120 and flow at the lower inside of the heat dissipation pipes 120.

The heat medium may be accommodated in the flow part 113 of the jacket tank 110 and may exchange heat with the reactor vessel 10 through the heat dissipation pipes 120. Such a heat medium may include sodium.

The second cooling unit 200 may receive the water coolant W discharged from the first cooling unit 100 and cool the water coolant W through an external fluid. The second cooling unit 200 may be formed such that the water coolant W cooled by the second cooling unit 200 flows back to the first cooling unit 100 in the normal position or the abnormal position. In addition, the second cooling unit 200 may be formed such that the water coolant W in the second cooling unit 200 is cooled by exchanging heat with the external fluid to flow downward and to be adjacent to the ground when the reactor cooler 20 is in the normal position or the abnormal position. The second cooling unit 200 may include a heat pipe 210, a fluid tank 220, and a communication member 230.

The heat pipe 210 may cool the water coolant W by exchanging heat between the external fluid and the water coolant W flowing from the first cooling unit 100 through the flow passage 310. The heat pipe 210 may be disposed in the fluid tank 220, and the water coolant W in the heat pipe 210 may be cooled by exchanging heat with a fluid in the fluid tank 220.

The heat pipe 210 may be inclined and extended with respect to an axis perpendicular to the ground. The heat pipe 210 may include a plurality of first heat pipes 211 and a plurality of second heat pipes 212. In addition, the first heat pipes 211 and the second heat pipes 212 may extend to be inclined in different directions.

When the water coolant Win the heat pipe 210 is in the normal position or the abnormal position, gaseous water coolant W flowing from the first cooling unit 100 can be introduced into the upper inside of the heat pipe 210 to flow in the upper inside of the heat pipe 210. The gaseous water coolant W flowing in the upper side of the heat pipe 210 can be cooled by exchanging heat with the fluid in the fluid tank 220.

When the water coolant W is in the normal position or the abnormal position, the water coolant W in the heat pipe 210 can be cooled by exchanging heat with the fluid in the fluid tank 220 so that the water coolant W flows downward to be adjacent to the ground. In other words, the liquid water coolant W cooled by heat exchange with the fluid in the fluid tank 220 can flow downward to the ground within the heat pipe 210.

The fluid tank 220 may contain a fluid (e.g., water) therein. In addition, the heat pipe 210 is disposed in the fluid tank 220 such that the water coolant W in the heat pipe 210 can exchange heat with the water in the fluid tank 220. When the water in the fluid tank 220 is evaporated through heat exchange, the evaporated gas can be discharged to the outside of the fluid tank 220. In this case, the fluid tank 220 is filled with air, and the air can exchange heat with the water coolant W in the heat pipe 210. Vapor holes 221 may be formed in the fluid tank 220.

The vapor holes 221 may be formed on one or more of one side and the other side of the fluid tank 220. When the water in the fluid tank 220 is evaporated through heat exchange with the water coolant W in the heat pipe 210, the evaporated gas can be discharged to the outside of the fluid tank 220 through the vapor holes 221. Meanwhile, a fluid tank opening and closing unit 400 may be provided in the vapor holes 221 to block the water in the fluid tank 220 from being discharged to the outside and to discharge gas evaporated through heat exchange of water to the outside, which will be described later.

The communication member 230 connects the flow line 300 and the heat pipe 210 and may provide an accommodation space in which the water coolant W can pass from the flow line 300 to the heat pipe 210 or from the heat pipe 210 to the flow line 300. The communication member 230 may be disposed at an inner corner of the fluid tank 220.

The flow line 300 may be connected to the first cooling unit 100 and the second cooling unit 200 to provide a passage through which the water coolant W flows such that the water coolant W circulates between the first cooling unit 100 and the second cooling unit 200. The flow line 300 may be connected to the first manifold part 111 and the second manifold part 112 such that the water coolant W is discharged at the upper side relatively spaced apart from the ground and is introduced at the lower side relatively adjacent to the ground when the reactor cooler 20 is in the normal position or the abnormal position. The flow line 300 may include the flow passage 310 and the flow channel 320.

The flow passage 310 may provide a path through which the water coolant W flows from the first manifold part 111 to one side of the heat pipe 210. The flow passage 310 may include a first flow passage 311 and a second flow passage 312.

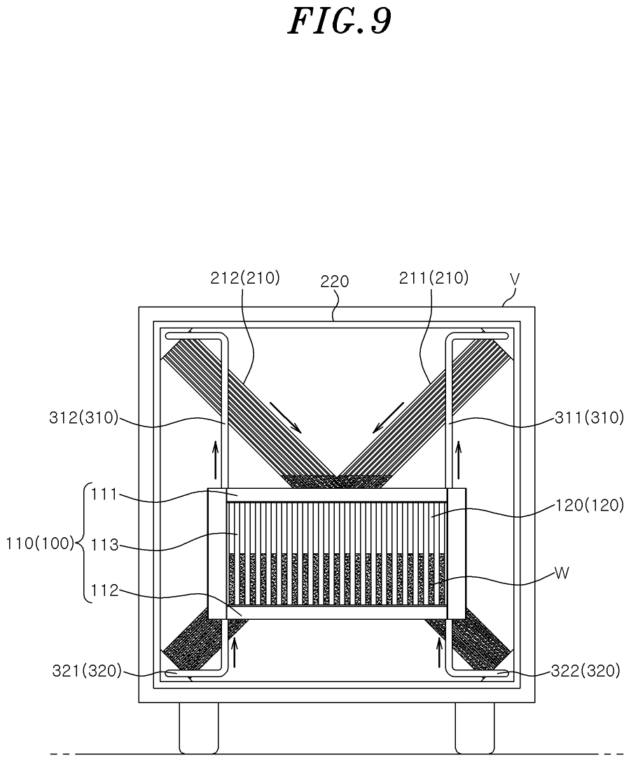

The first flow passage 311 may be connected to the first manifold part 111 and an upper part (right upper part in FIG. 9) of the first heat pipe 211 in the normal position. For example, the first flow passage 311 may provide a path through which gaseous water coolant flows from the first manifold part 111 to the upper part of the first heat pipe 211 in the normal position.

The second flow passage 312 may be connected to the first manifold part 111 and the upper part (the left upper part in FIG. 9) of the second heat pipe 212 in the normal position. For example, the second flow passage 312 may provide a path through which gaseous water coolant flows from the first manifold part 111 to the upper part of the second heat pipe 212 in the normal position.

The flow channel 320 may provide a path through which the water coolant W flows from the other side of the heat pipe 210 to the second manifold part 112. The flow channel 320 may include a first flow channel 321 and a second flow channel 322.

The first flow channel 321 may be connected to the second manifold part 112 and the lower part (left lower part in FIG. 9) of the first heat pipe 211 in the normal position. For example, the first flow channel 321 may provide a path through which liquid water coolant W flows from the lower part of the first heat pipe 211 to the second manifold part 112 in the normal position.

The second flow channel 322 may be connected to the second manifold part 112 and the lower part (right lower part in FIG. 9) of the second heat pipe 212 in the normal position. For example, the second flow channel 322 may provide a path through which the liquid water coolant W flows from the lower part of the second heat pipe 212 to the second manifold part 112 in the normal position.

A path through which the water coolant W flows through the first flow passage 311, the second flow passage 312, the first flow channel 321, and the second flow channel 322 of the flow line 300 in the abnormal position will be described later.

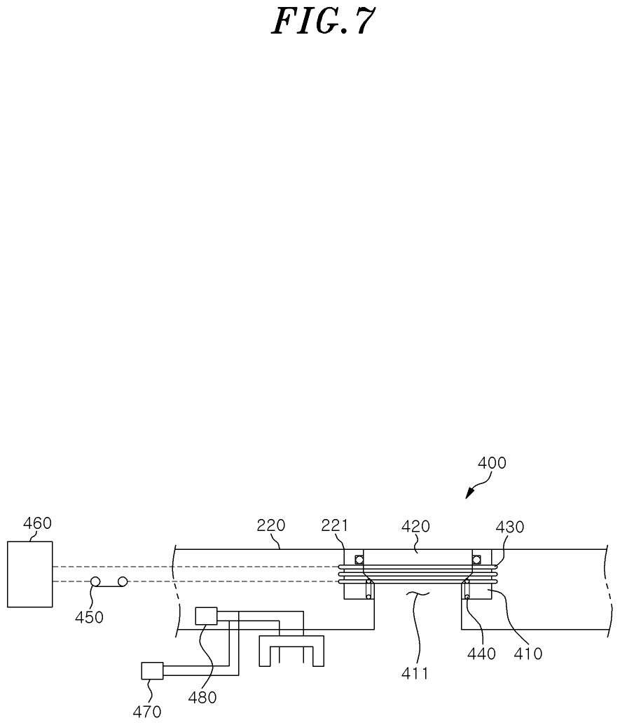

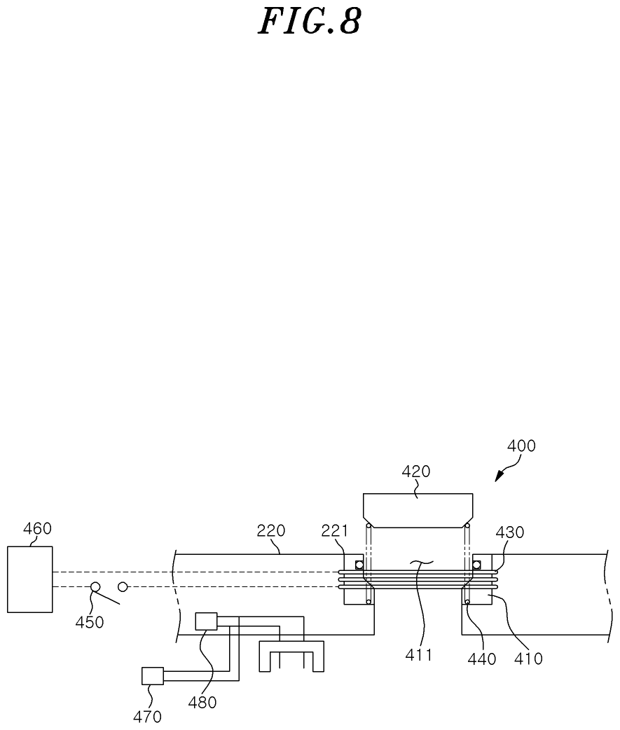

Referring to FIGS. 7 and 8, the fluid tank opening and closing unit 400 may be configured to block water from being discharged to the outside of the fluid tank 220 when the water is accommodated in the fluid tank 220. In addition, the fluid tank opening and closing unit 400 may be configured to discharge evaporated gas to the outside of the fluid tank 220 when the water in the fluid tank 220 is evaporated through heat exchange with the water coolant W in the heat pipe 210. The fluid tank opening and closing unit 400 may include a magnetization member 410, a cover member 420, a coil 430, an elastic member 440, a switch 450, a power supply 460, a sensor 470, and a battery 480.

A flow passage 411 is formed in the magnetization member 410, and the flow passage 411 may be closed when the cover member 420 is inserted into the flow passage 411 and may be opened when the cover member 420 is moved away from the flow passage 411. The magnetization member 410 is disposed in the vapor hole 221 of the fluid tank 220, and the water in the fluid tank 220 can be blocked from being discharged to the outside when the flow passage 411 is closed and evaporated gas in the fluid tank 220 can be discharged to the outside of the fluid tank 220 through the flow passage 411 when the flow passage 411 is opened. The coil 430 may surround the magnetization member 410, and when power is applied to the coil 430 by the power supply 460 or the battery 480, electromagnetic force can be generated in the magnetization member 410.

The cover member 420 may be moved to be inserted into or separated from the flow passage 411 of the magnetization member 410. For example, when power is applied to the coil 430 surrounding the magnetization member 410, an attractive force is applied to the magnetization member 410 by electromagnetic force and thus the cover member 420 can be moved to be inserted into the flow passage 411 of the magnetization member 410. When the cover member 420 is inserted into the flow passage 411 of the magnetization member 410, the fluid in the fluid tank 220 can be blocked from being discharged to the outside of the fluid tank 220. In addition, the cover member 420 may be moved to be separated from the magnetization member 410 by the elastic force of the elastic member 440 when power is not applied to the coil 430 surrounding the magnetization member 410. When the cover member 420 is moved away from the magnetization member 410, the flow passage 411 of the magnetization member 410 is opened and the gas in the fluid tank 220 can be discharged to the outside of the fluid tank 220 through the flow passage 411.

The coil 430 surrounds the magnetization member 410 and can generate an electromagnetic force when power is applied thereto from the power supply 460 or the battery 480.

The elastic member 440 may provide an elastic force such that the cover member 420 moves in a direction away from the magnetization member 410. For example, when power is not applied to the coil 430, the cover member 420 may be moved away from the magnetization member 410 by the elastic force of the elastic member 440. One side of the elastic member 440 may contact the lower end of the cover member 420 and the other side may contact the inner lower end of the magnetization member 410.

The switch 450 may be opened and closed to selectively apply power to the coil 430. For example, when water is accommodated in the fluid tank 220, the switch 450 may be turned on and thus power can be applied to the coil 430. In this case, the cover member 420 is inserted into the flow passage 411 of the magnetization member 410 to prevent the water in the fluid tank 220 from being discharged to the outside of the fluid tank 220. In addition, when the water in the fluid tank 220 is evaporated according to heat exchanged, the switch 450 is turned off and thus no power is applied to the coil 430. In this case, the cover member 420 is moved away from the magnetization member 410 and thus the gas in the fluid tank 220 can be discharged to the outside of the fluid tank 220 through the flow passage 411 of the magnetization member 410.

The power supply 460 can apply power to the coil 430. For example, when the reactor cooler 20 is in the abnormal position, such as when the vehicle is overturned, the power supply 460 may be controlled by a separate controller (not shown) to apply power to the coil 430. When power is applied to the coil 430 by the power supply 460, the cover member 420 is inserted into the flow passage 411 of the magnetization member 410 and thus the water in the fluid tank 220 can be blocked from being discharged to the outside of the fluid tank 220.

The sensor 470 may detect the electrical conductivity of the water in the fluid tank 220 when some water in the fluid tank 220 is evaporated into gas through heat exchange.

The battery 480 may apply power to the coil 430 when the power of the power supply 460 is consumed. The battery 480 may be connected to the sensor 470 and a controller to selectively apply power to the coil 430. For example, when the power of the power supply 460 is consumed and the sensor 470 detects water in the fluid tank 220, the battery 480 may be controlled by the controller to apply power to the coil 430. In this case, the cover member 420 may be inserted into the flow passage 411 of the magnetization member 410 to prevent the water in the fluid tank 220 from being discharged to the outside of the fluid tank 220. In addition, when the power of the power supply 460 is consumed, and only gas contacts the sensor 470 and thus the sensor 470 does not detect water, the battery 480 may be controlled by the controller such that it does not apply power to the coil 430. In this case, the cover member 420 is moved away from the magnetization member 410 such that the gas in the fluid tank 220 can be discharged to the outside of the fluid tank 220 through the flow passage 411 of the magnetization member 410.

In this way, the fluid tank opening and closing unit 400 can block the water in the fluid tank 220 from being discharged to the outside of the fluid tank 220 when the water is accommodated in the fluid tank 220, and when the water in the fluid tank 220 is evaporated through heat exchange, discharge the evaporated gas to the outside of the fluid tank 220. Accordingly, the discharge of the water in the fluid tank 220 to the outside can be blocked and gas can be discharged to the outside when the reactor cooler 20 is not only in the normal position but also in the abnormal position.

The molten salt cooler 30 may cool the molten salt flowing in the reactor vessel 10. For example, the molten salt cooler 30 may cool the molten salt in the reactor vessel 10 by circulating the molten salt to the outside of the reactor vessel 10. The molten salt cooler 30 may include a heat exchanger 31, a discharge channel 32, and an inlet channel 33.

The heat exchanger 31 may cool the molten salt discharged from the reactor vessel 10. The heat exchanger 31 may be spaced apart from the reactor vessel 10 by a predetermined distance. Meanwhile, the heat exchanger 31 may be formed in a relatively small size such that it can be accommodated in the containment case 50.

The discharge channel 32 may provide a path through which the molten salt flows from the reactor vessel 10 to the heat exchanger 31. The molten salt at a relatively high temperature in the reactor vessel 10 may flow to the heat exchanger 31 through the discharge channel 32. The discharge channel 32 may be connected to the upper part of the reactor vessel 10.

The inlet channel 33 may provide a path through which cooled molten salt flows from the heat exchanger 31 to the reactor vessel 10. The molten salt at a relatively low temperature cooled by the heat exchanger 31 may flow back to the reactor vessel 10 through the inlet channel 33. This inlet channel 33 may be connected to the lower part of the reactor vessel 10.

The circulation pump 40 may flow the cooled molten salt from the heat exchanger 31 to the reactor vessel 10. The circulation pump 40 may be disposed at the inlet channel 33. For example, the circulation pump 40 may be disposed at the inflow channel 33 connected to the lower part of the reactor vessel 10 such that the circulation pump 40 can be prevented from protruding to the upper part of the reactor vessel 10, and the circulation pump 40 can be prevented from being damaged by flowing the cooled molten salt at a relatively low temperature.

The containment case 50 may accommodate the reactor vessel 10, the first cooling unit 100, and the molten salt cooler 30. One side of the containment case 50 may be connected to the fluid tank 220 to cover the open surface of the fluid tank 220. Accordingly, a fluid can be contained in the fluid tank 220. In addition, the containment case 50 connected to the fluid tank 220 may be accommodated in a transportation means V such as a vehicle.

Hereinafter, operations and effects of the reactor residual heat removal apparatus 1 for mounting on a vehicle having the configuration described above will be described with reference to FIGS. 9 to 12.

When the vehicle is operated normally, the reactor cooler 20 mounted in the vehicle may be placed in the normal position. In the reactor cooler 20 in the normal position, one side (upper end in FIG. 9) of the first heat pipe 211 and the second heat pipe 212 may be located in the upper side spaced apart from the ground, and the other side (the lower end in FIG. 9) may be located in the lower side adjacent to the ground. In this case, gaseous water coolant W may flow in the heat dissipation pipes 120 located in the upper side among the plurality of heat dissipation pipes 120 of the first cooling unit 100, and liquid water coolant W may flow in the heat dissipation pipes 120 located in the lower side among the plurality of heat dissipation pipes 120. Further, in this case, the gaseous water coolant W may flow in the first manifold part 111 and the liquid water coolant W may flow in the second manifold part 112. The gaseous water coolant W introduced from the heat dissipation pipes 120 through the first flow passage 311 and the second flow passage 312 may flow at the upper side within the first heat pipe 211 and the second heat pipe 212, and the liquid coolant W cooled by heat exchange with the fluid in the fluid tank 220 may flow downward in the first heat pipe 211 and the second heat pipe 212 and may be discharged through the first flow channel 321 and the second flow channel 322.

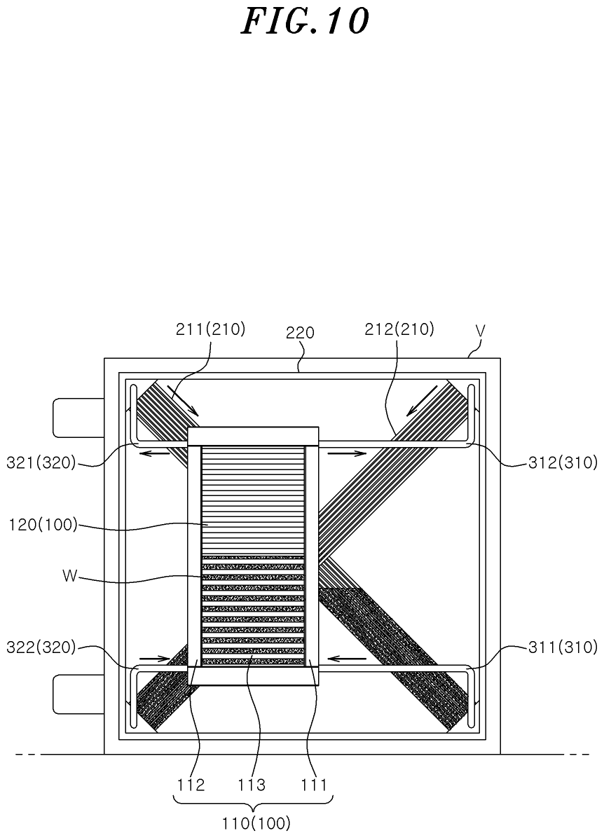

The reactor cooler 20 may be in the abnormal position due to overturning of the vehicle or the like. For example, when the heat pipe 210 is rotated in one direction (clockwise in FIG. 9), the heat pipe 210 may be placed in a first abnormal position in which one side (right lower part in FIG. 10) of the first heat pipe 211 may be located in the lower side adjacent to the ground and the other side (left upper part in FIG. 10) of the first heat pipe 211 may be located on the upper side spaced apart from the ground. In this case, the gaseous water coolant W may flow in the heat dissipation pipes 120 located on the upper side among the plurality of heat dissipation pipes 120 of the first cooling unit 100, and the liquid water coolant W may flow in the heat dissipation pipes 120 located on the lower side among the plurality of heat dissipation pipes. In addition, in this case, the gaseous water coolant W may flow at the upper sides in the first manifold part 111 and the second manifold part 112, and the liquid water coolant W may flow at the lower sides in the first manifold part 111 and the second manifold part 112. The gaseous water coolant W introduced from the heat dissipation pipes 120 through the first flow channel 321 may flow at the upper side within the first heat pipe 211, and the liquid water coolant W cooled by exchanging heat with the fluid in the fluid tank 220 may flow downward in the first heat pipe 211 and may be discharged through the first flow passage 311.

In addition, in the first abnormal position, one side (right upper part in FIG. 10) of the second heat pipe 212 may be located in the upper side spaced apart from the ground, and the other side (left lower part in FIG. 10) of the second heat pipe 212 may be located in the lower side adjacent to the ground. The gaseous water coolant W introduced from the heat dissipation pipes 120 through the second flow passage 312 may flow at the upper side within the second heat pipe 212, and the liquid water coolant W cooled by exchanging heat with the fluid in the fluid tank 220 may flow downward in the second heat pipe 212 and may be discharged through the second flow channel 322.

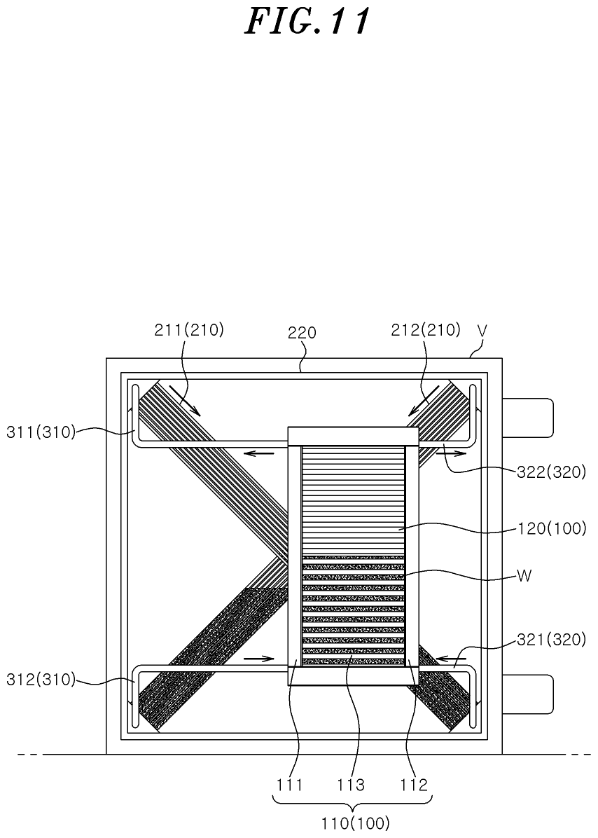

Further, the reactor cooler 20 may be placed in a second abnormal position due to overturning of the vehicle, or the like. For example, when the heat pipe 210 is rotated in the other direction (counterclockwise in FIG. 9), one side (left upper part in FIG. 11) of the first heat pipe 211 may be located in the upper side spaced apart from the ground, and the other side (right lower part in FIG. 11) of the first heat pipe 211 may be located in the lower side adjacent to the ground. In this case, the gaseous water coolant W may flow in the heat dissipation pipes 120 located on the upper side among the plurality of heat dissipation pipes 120 arranged in the first cooling unit 100, and the liquid water coolant W may flow in the heat dissipation pipes 120 located in the lower side among the plurality of heat dissipation pipes. In addition, in this case, the gaseous water coolant W may flow at the upper sides in the first manifold part 111 and the second manifold part 112, and the liquid water coolant W may flow at the lower sides in the first manifold part 111 and the second manifold part 112. The gaseous water coolant W introduced from the heat dissipation pipes 120 through the first flow passage 311 may flow at the upper side within the first heat pipe 211, and the liquid water coolant W cooled by exchanging heat with the fluid in the fluid tank 220 may flow downward in the first heat pipe 211 and may be discharged through the first flow channel 321.

In addition, in the second abnormal position, one side (left lower part in FIG. 11) of the second heat pipe 212 may be located in the lower side adjacent to the ground, and the other side (right upper part in FIG. 11) of the second heat pipe 212 may be located in the upper side spaced apart from the ground. The gaseous water coolant W introduced from the heat dissipation pipes 120 through the second flow channel 322 may flow at the upper side within the second heat pipe 212, and the liquid water coolant W cooled by exchanging heat with the fluid in the fluid tank 220 may flow downward in the second heat pipe 212 and may be discharged through the second flow passage 312.

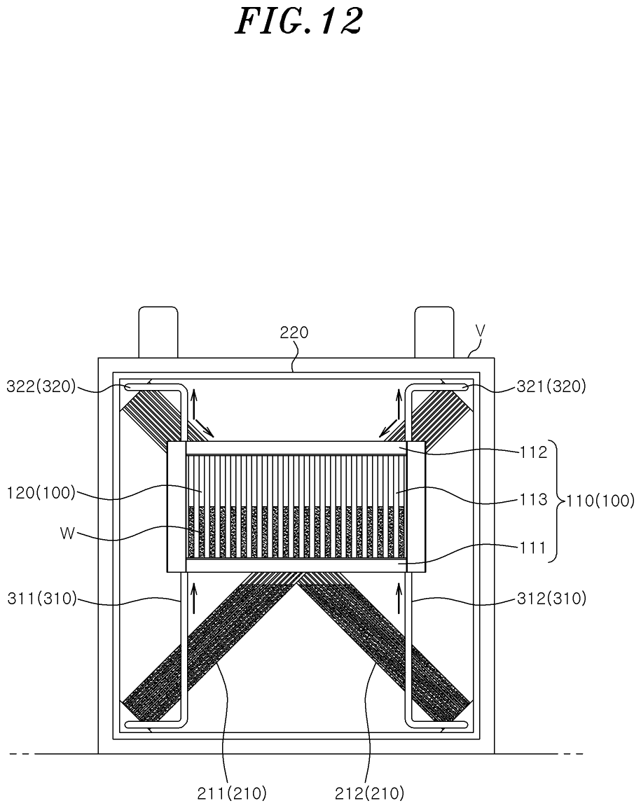

Further, the reactor cooler 20 may be placed in a third abnormal position due to overturning of the vehicle, or the like. When the vehicle is overturned to a relatively large extent, the heat pipe 210 may be rotated more largely in one direction or in other direction and placed in the third abnormal position (in the position as shown in FIG. 12). In the third abnormal position, one side (lower part in FIG. 12) of the first heat pipe 211 and the second heat pipe 212 may be located in the lower side adjacent to the ground, and the other side (upper part in FIG. 12) of the first heat pipe 211 and the second heat pipe 212 may be located in the upper side spaced apart from the ground. In this case, the gaseous water coolant W may flow in the heat dissipation pipes 120 located in the upper side among the plurality of heat dissipation pipes 120 of the first cooling unit 100, and the liquid water coolant W may flow in the heat dissipation pipes 120 located in the lower side among the plurality of heat dissipation pipes. In addition, in this case, the gaseous water coolant W may flow in the second manifold part 112, and the liquid water coolant W may flow in the first manifold part 111. The gaseous water coolant W introduced from the heat dissipation pipes 120 through the first flow channel 321 and the second flow channel 322 may flow at the upper sides within the first heat pipes 211 and the second heat pipe 212, and the liquid water coolant W cooled by exchanging heat with the fluid in the fluid tank 220 may flow downward in the first heat pipe 211 and the second heat pipe 212 and may be discharged through the first flow passage 311 and the second flow passage 312.

As described above, the reactor residual heat removal apparatus 1 according to the present disclosure is installed in a transportation means V such as a vehicle and can remove residual heat of molten salt flowing in the reactor vessel 10. In addition, the reactor residual heat removal apparatus 1 can remove residual heat of the reactor vessel 10 using the first cooling unit 100 and the second cooling unit 200 of the reactor cooler 20 not only when the vehicle is in a normal position due to normal operation, but also when the vehicle is in the abnormal position due to overturning or the like.

In addition, when water is contained in the fluid tank 220, discharge of the water to the outside of the fluid tank 220 can be blocked, and when the water in the fluid tank 220 is evaporated through heat exchange, the evaporated gas can be discharged to the outside of the fluid tank 220 by the fluid tank opening and closing unit 400 not only in the normal position but also in abnormal positions.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. An apparatus for eliminating residual heat of a nuclear reactor for vehicle mounting, the apparatus comprising:
a reactor vessel in which molten salt flows; and
a reactor cooler for cooling the reactor vessel,
wherein the reactor cooler includes:
a first cooling unit including a heat medium that exchanges heat with the reactor vessel, and one or more heat dissipation pipes providing passages through which water coolant flows; and
a second cooling unit configured to receive the water coolant discharged from the first cooling unit and cool the water coolant through an external fluid, and
wherein the second cooling unit is configured such that the cooled water coolant flows into the first cooling unit in a normal position and in an abnormal position inclined to be perpendicular to the normal position.

2. The apparatus of claim 1, wherein the first cooling unit is configured such that the water coolant in the first cooling unit is heated by exchanging heat with the reactor vessel and flows upward to be separated from a ground when the reactor cooler is in the normal position and in the abnormal position.

3. The apparatus of claim 2, wherein the first cooling unit is configured such that the water coolant is discharged at an upper side spaced apart from the ground and the water coolant is introduced at a lower side adjacent to the ground when the reactor cooler is in the normal position and in the abnormal position.

4. The apparatus of claim 2, wherein the one or more heat dissipation pipes are a plurality of heat dissipation pipes, and the first cooling unit further includes a jacket tank filled with the heat medium and communicating with the plurality of the heat dissipation pipes.

5. The apparatus of claim 4, wherein the jacket tank includes:
a first manifold part connected to one side of the plurality of heat dissipation pipes to communicate with the plurality of heat dissipation pipes; and
a second manifold part connected to the other side of the plurality of heat dissipation pipes to communicate with the plurality of heat dissipation pipes.

6. The apparatus of claim 5, further comprising:
a flow line connected to the first cooling unit and the second cooling unit to provide a passage through which the water coolant flows to circulate between the first cooling unit and the second cooling unit,
wherein the flow line is connected to the first manifold part and the second manifold part such that the water coolant is discharged at the upper side spaced apart from the ground and introduced at the lower side adjacent to the ground when the reactor cooler is in the normal position and in the abnormal position.

7. The apparatus of claim 5, wherein the jacket tank further includes:
a flow part accommodating the heat medium, and
wherein the plurality of the heat dissipation pipes are disposed in the flow part to be surrounded by the heat medium.

8. The apparatus of claim 1, wherein the second cooling unit includes a heat pipe for cooling the water coolant by exchanging heat with an external fluid and the water coolant introduced from the first cooling unit, and
wherein the second cooling unit is configured such that the water coolant in the second cooling unit is cooled by exchanging heat with the external fluid and flows downward to be adjacent to the ground when the reactor cooler is in the normal position and in the abnormal position.

9. The apparatus of claim 8, wherein the heat pipe extends to be inclined with respect to an axis perpendicular to the ground,
wherein one end of the heat pipe is located in an upper position spaced apart from the ground and the other end is located in a lower position adjacent to the ground in the normal position, and
wherein the one end is located in a lower position adjacent to the ground and the other end is located in an upper position spaced apart from the ground when rotated in one direction and placed in a first abnormal position.

10. The apparatus of claim 9, wherein, when the heat pipe is rotated in a direction opposite to the one direction and positioned in a second abnormal position, the one end of the heat pipe is located in an upper position spaced apart from the ground and the other end of the heat pipe is located in a lower position adjacent to the ground.

11. The apparatus of claim 9, wherein the heat pipe includes a plurality of first heat pipes and a plurality of second heat pipes, and
wherein the plurality of first heat pipes and the plurality of second heat pipes extend to be inclined in different directions with respect to the ground.

12. The apparatus of claim 9, wherein the second cooling unit further includes a fluid tank in which the heat pipe is disposed, a fluid is contained, and vapor holes are formed, and
wherein, when the fluid in the fluid tank is evaporated by exchanging heat with the water coolant in the heat pipe, the evaporated gas is discharged to an outside of the fluid tank through the vapor holes.

13. The apparatus of claim 6, wherein the second cooling unit includes a heat pipe for cooling the water coolant by exchanging heat with an external fluid and the water coolant introduced from the first cooling unit, and
wherein the flow line includes:
a flow passage providing a path through which the water coolant flows from the first manifold part to one end of the heat pipe; and
a flow channel providing a path through which the water coolant flows from the other end of the heat pipe to the second manifold part.

14. The apparatus of claim 13, wherein the heat pipe includes a plurality of first heat pipes and a plurality of second heat pipes, and
wherein the flow passage includes:
a first flow passage connected to the first manifold part and upper parts of the plurality of first heat pipes in the normal position; and
a second flow passage connected to the first manifold part and upper parts of the plurality of second heat pipes in the normal position.

15. The apparatus of claim 13, wherein the heat pipe includes a plurality of first heat pipes and a plurality of second heat pipes, and
wherein the flow channel includes:
a first flow channel connected to the second manifold part and lower parts of the plurality of first heat pipes in the normal position; and
a second flow channel connected to the second manifold part and lower parts of the plurality of second heat pipes in the normal position.

16. The apparatus of claim 1, further comprising:
a molten salt cooler for cooling the molten salt in the reactor vessel,
wherein the molten salt cooler includes:
a heat exchanger for cooling the molten salt discharged from the reactor vessel;
a discharge channel providing a path through which the molten salt flows from the reactor vessel to the heat exchanger; and
an inlet channel providing a path through which the molten salt cooled flows from the heat exchanger to the reactor vessel.

17. The apparatus of claim 16, further comprising: a circulation pump disposed at the inlet channel to flow the cooled molten salt from the heat exchanger to the reactor vessel,
wherein the discharge channel is connected to an upper part of the reactor vessel, and the inlet channel is connected to a lower part of the reactor vessel.
